(19) United States
(12) Patent Application Publication
(10) Pub. No.: US 2012/0057344 A1
(43) Pub. Date: Mar. 8, 2012

(54) LED DISC LAMP

(76) Inventor: Robert Wang, Luch (TW)

(21) Appl. No.: 12/877,224

(22) Filed: Sep. 8, 2010

(51) Int. Cl. F21V 1/00; F21V 7/00

(52) U.S. Cl. 362/235

(57) ABSTRACT

A light emitting diode (LED) disc lamp includes a lamp base, a plurality of LED modules on the lamp base and a lampshade to cover the lamp base. The lamp base is made of aluminum. The lamp base includes a bottom plate which is integrally formed with a circular trough by stamping. The circular trough has a circumferential wall and a bottom which are formed with a plurality of apertures. Each of the plurality of LED modules includes a heat sink fin which is disposed in the circular trough of the lamp base. The LED modules can be replaced with ease. The heat generated from the LED modules can be radiated effectively. The height of the disc lamp can be reduced to beautify the disc lamp.

### BACKGROUND OF THE INVENTION

1. Field of the Invention

The present invention relates to a LED disc lamp.

2. Description of the Prior Art

A fluorescent tube consumes more power and has mercury and fluorescent powder which are harmful to the human body. Recently, LED lamps are widely used instead of fluorescent lamps. However, the light emitting diodes of a conventional LED lamp are fixed to a lamp base. In case one of the light emitting diodes malfunctions, the illumination is not even. This also influences the sense of sight for beauty. In order to overcome the aforesaid problem, it is necessary to replace the entire lamp, which costs a lot of money, increases the amount of trash, and is not friendly to environmental protection. Besides, the bottom of the light emitting diode is coated with glue to radiate the heat from the light emitting diode to the lamp base. The heat is still in the lamp, which cannot radiate heat effectively. Accordingly, the inventor of the present invention has devoted himself based on his many years of practical experiences to solve this problem.

### SUMMARY OF THE INVENTION

The primary object of the present invention is to provide a light emitting diode (LED) disc lamp, which can radiate the heat generated from light emitting diodes of LED modules out of the disc lamp, providing a better effect to radiate heat.

Another object of the present invention is to provide a light emitting diode (LED) disc lamp, which can reduce the entire height of the disc lamp to beautify the disc lamp.

A further object of the present invention is to provide a light emitting diode (LED) disc lamp, which can replace the LED modules with ease and is environmentally friendly.

According to the present invention, there is provided a light emitting diode (LED) disc lamp. The LED disc lamp comprises a lamp base, a plurality of LED modules on the lamp base and a lampshade to cover the lamp base. The lamp base is made of aluminum which is easy to radiate heat. The lamp base comprises a bottom plate. The bottom plate is integrally formed with a circular trough by stamping. The circular trough has a circumferential wall and a bottom which are formed with a plurality of apertures. The LED modules are disposed in the circular trough of the lamp base. Each of the plurality of LED modules comprises a base plate, a plurality of light emitting diodes on the base plate, and a heat sink fin under the base plate. The heat sink fin is substantially half embedded in the circular trough of the lamp base.

### BRIEF DESCRIPTION OF THE DRAWINGS

FIG. 1 is an exploded view according to a preferred embodiment of the present invention;

FIG. 2 is a cross-sectional view according to the preferred embodiment of the present invention;

FIG. 3 is a partially enlarged view according to the preferred embodiment of the present invention; and

FIG. 4 is a schematic view to show the LED modules mounted on the lamp base to form a ring according to the preferred embodiment of the present invention;

### DETAILED DESCRIPTION OF THE PREFERRED EMBODIMENTS

Embodiments of the present invention will now be described, by way of example only, with reference to the accompanying drawings.

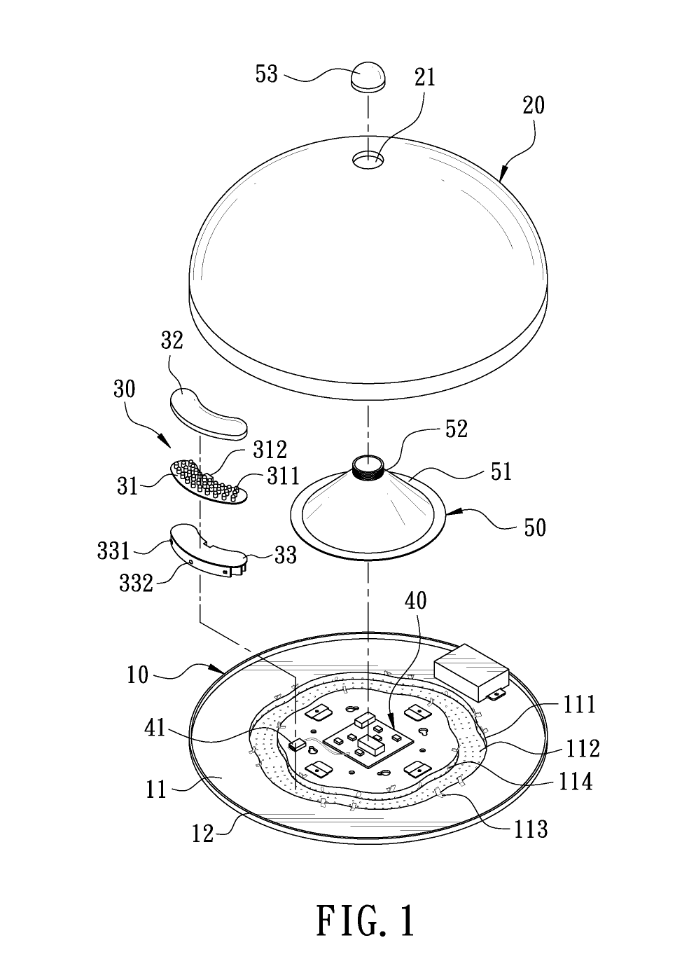

As shown in FIG. 1, a disc lamp according to a preferred embodiment of the present invention comprises a lamp base 10, a lampshade 20, a plurality of LED (light emitting diode) modules 30, a power supply control circuit board 40, and a light reflection cover 50.

The lamp base 10 is made of aluminum which is easy to radiate heat. The lamp base 10 is in a disc shape. The lamp base 10 comprises a bottom plate 11 and a circular wall 12 extending upward from the bottom plate 11. The bottom plate 11 is integrally formed with a circular trough 111 by stamping. The circular trough 111 has a circumferential wall and a bottom which are formed with a plurality of apertures 112. The bottom plate 11 has a plurality of first engaging members 113 and a plurality of first positioning members 114 disposed around the circular trough 111. The first engaging members 113 are integrally formed with the bottom plate 11 by stamping to form an elastic piece which has a free end and a fixed end. The first positioning members 114 are notches which are integrally formed with the bottom plate 11 by stamping.

The lampshade 20 is made of a material which is pervious to light. The lampshade 20 has a camber surface and is disposed on the light base 10. The lampshade 20 has a central through hole 21.

Each of the plurality of LED modules 30 corresponds to the circular trough 111 of the lamp base 10 and has a curved shape like a ham shape. Each of the plurality of LED modules 30 comprises a base plate 31, an outer lid 32 and a heat sink fin 33. The base plate 31 comprises a plurality of light emitting diodes 311 thereon and a socket 312 at one side thereof. The light emitting diodes 311 are ranked in a plurality of curved lines corresponding to the curved shape of the LED module 30. The outer lid 32 is fitted on the base plate 31. The outer lid 32 has a curved shape and is made of a material which is pervious to light and has a specific color for the LED module 30 to mix light. The heat sink fin 33 of each of the LED modules 30 extends downward from the bottom of the base plate 31. An outer side of the heat sink fin 33 has a second engaging member 331 and a second positioning member 332 corresponding to the first engaging member 113 and the first positioning member 114 of the bottom plate 11. The second engaging member 331 is a raised block protruding outward from the heat sink fin 33. The second engaging member 331 has a thickness which is enlarged from bottom to top.

The power supply control circuit board 40 is fixed on the center of the bottom plate 11 of the lamp base 10. The power supply control circuit board 40 has a plurality of connection plugs 41 corresponding in number to the LED modules 30. The connection plugs 41 are connected to the sockets 312 of the LED modules 30.

The light reflection cover 50 is fixed on the center of the bottom plate 11 of the lamp base 10 and has a cone shape which is enlarged from top to bottom. The power supply control circuit board 40 is located in the light reflection cover 50. An outer wall of the light reflection cover 50 is wrapped with a light reflection member 51, such as a piece of light reflection paper, so that the light reflection cover 50 has a light reflection effect. An upper end of the light reflection cover 50 is provided with a pipe 52 to be inserted through the through hole 21 of the lampshade 20 and exposed out of the lampshade 20. An outer wall of the pipe 52 has threads. The light reflection cover 50 has a lid 53. The lid 53 has inner threads corresponding to the threads on the outer wall of the pipe 52, so the lid 53 is screwed to the pipe 52.

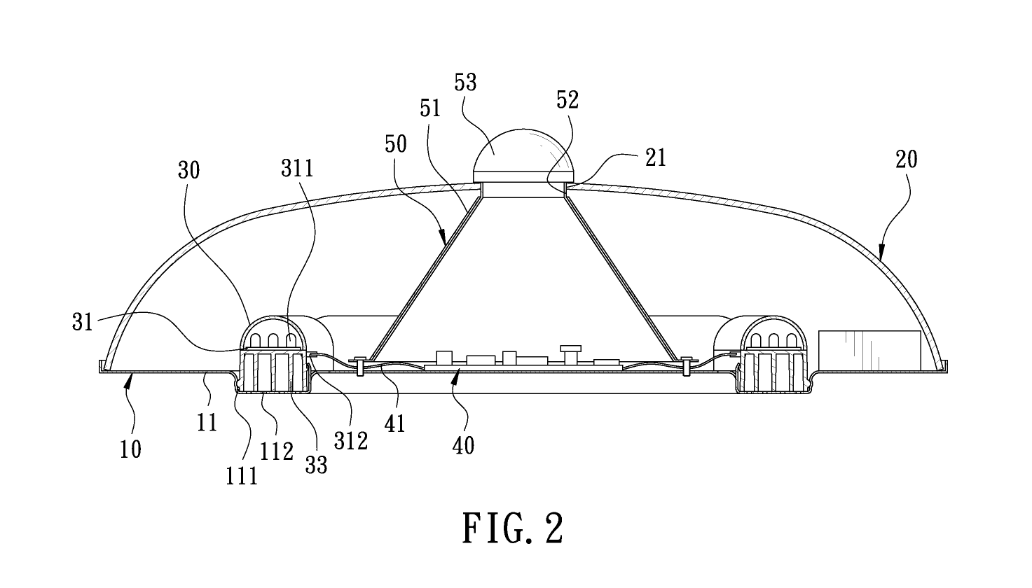

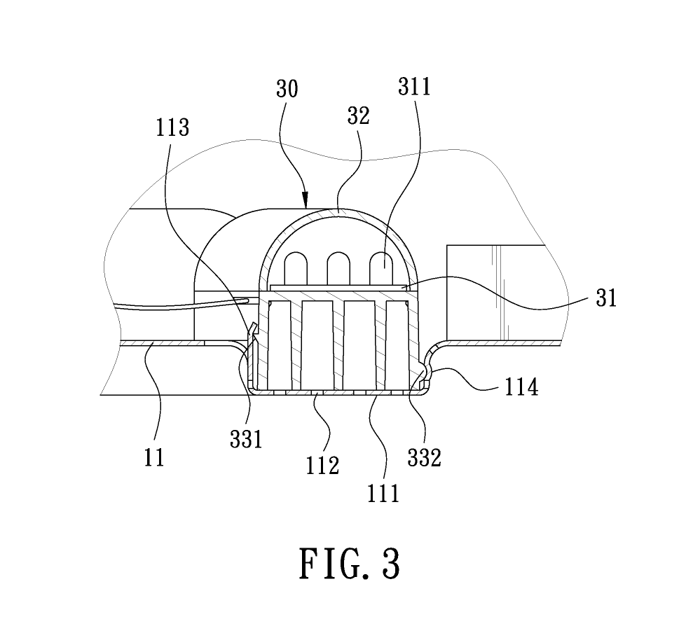

FIG. 2 is a cross-sectional view of the present invention. FIG. 3 is a partially enlarged view of the present invention. To assemble the present invention, the LED modules 30 are placed in the circular trough 111 of the bottom plate 11 in sequence. The first engaging members 113 of the bottom plate 11 engage with the second engaging members 331 of the LED modules 30 and the second positioning members 332 of the LED modules 30 are located in the first positioning members 114 of the bottom plate 11, so that the LED modules 30 are positioned in place. After that, the insertion plugs 41 of the power supply control circuit board 40 are inserted in the sockets 312 of the LED modules 30, respectively. Finally, the light reflection cover 50 is coupled to the bottom plate 11 of the lamp base 10. The pipe 52 is inserted through the through hole 21 of the lampshade 20, and the lid 53 is screwed to the pipe 52 so as to secure the lampshade 20. The assembly of the present invention is completed.

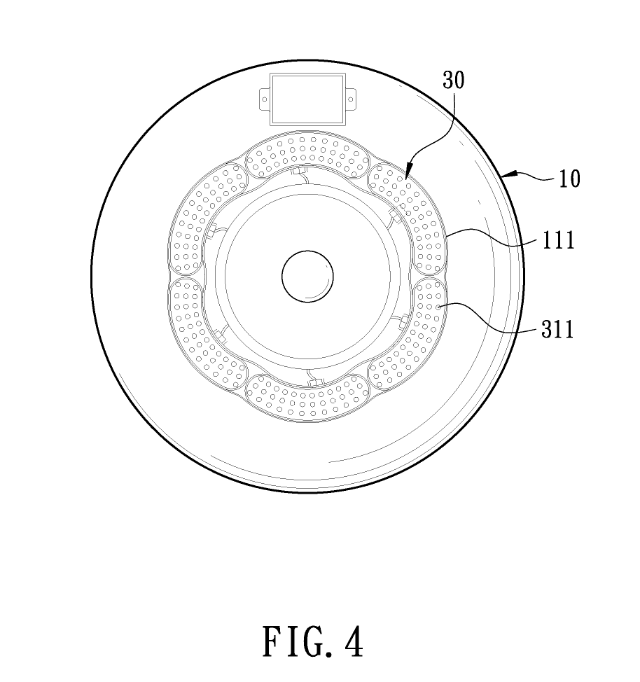

FIG. 4 is a schematic view showing that the LED modules are mounted on the lamp base to form a ring. All the LED modules 30 are placed in the circular trough 111 of the bottom plate 11 to form a ring. The light emitting diodes 311 of each LED module 30 are ranked in a plurality of curved lines to form a plurality of concentric circles. When the present invention is lighted, the lampshade will provide even brightness. The brightness of the disc lamp of the present invention depends on the number of the lamp circles.

When one of the LED modules 30 malfunctions, the user can pull the corresponding insertion plug 41 of the power supply control circuit board 40 out of the socket 312 of the LED module 30, and dismantle the LED module 30 from the lamp base 10, and then replace with a new LED module 30. The LED module 30 can be replaced with ease and repaired conveniently.

The features and effects of the present invention are as follows:

1. The lamp base 10 is made of aluminum which is easy to radiate heat and integrally formed with the circular trough 111 by stamping. The heat sink fin 31 of the LED module 30 is half embedded in the circular trough 111, such that the heat generated from light emitting diodes 311 of the LED modules 30 can be radiated out by the bottom plate 11 made of aluminum and by the apertures 112 formed in the circumferential wall and the bottom of the circular trough 111, providing a better effect to radiate heat.

2. The LED power source is composed of a plurality of LED modules 30. Each LED module 30 can be replaced separately. If one of the LED modules 30 malfunctions, it is not necessary to throw away the entire lamp. The user just replaces with a new LED module or repairs the damaged LED module. The user can save the expenditure and the trash can be decreased. The present invention is environmentally friendly and saves energy.

3. The heat sink fin 31 of the LED module 30 is half embedded in the circular trough 111 of the bottom plate 11 of the lamp base 10 to reduce the entire height of the disc lamp, so the disc lamp is beautiful.

4. The fixing structure of the lamp base 10 and lamp modules 30 uses the first engaging members 113 of the lamp base 10 to engage with the second engaging members 331 of the LED modules 30 and the second positioning members 332 of the LED modules 30 to engage with the first positioning members 114 of the bottom plate 11, such that the LED modules 30 can be secured and positioned quickly. It is very convenient to assemble or replace the LED modules 30.

5. The cone-shaped light reflection cover 50 of the present invention not only enhances the brightness of the LED modules 30 by reflection but also enlarges the illumination area due to the cone shape.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A light emitting diode (LED) disc lamp, the LED disc lamp comprising a lamp base, a plurality of LED modules on the lamp base and a lampshade to cover the lamp base, characterized by:
the lamp base being made of aluminum which is easy to radiate heat, the lamp base comprising a bottom plate, the bottom plate being integrally formed with a circular trough by stamping, the circular trough having a circumferential wall and a bottom which are formed with a plurality of apertures;
the plurality of LED modules being disposed in the circular trough of the lamp base, each of the plurality of LED modules comprising a base plate, a plurality of light emitting diodes on the base plate and a heat sink fin under the base plate, the heat sink fin being substantially half embedded in the circular trough of the lamp base.

2. The LED disc lamp as claimed in claim 1, wherein the circumferential wall of the circular trough of the lamp base has a plurality of first engaging members and a plurality of first positioning members, the LED modules have second engaging members corresponding in position to the first engaging members of the lamp base, and the LED modules have second positioning members corresponding in position to the first positioning members of the lamp base.

3. The LED disc lamp as claimed in claim 1, wherein each of the LED modules has a curved shape.

4. The LED disc lamp as claimed in claim 3, wherein the LED modules are arranged to form a ring.

5. The LED disc lamp as claimed in claim 3, wherein the light emitting diodes of each of the LED modules are ranked in a plurality of curved lines corresponding to the curved shape of each of the LED modules.

6. The LED disc lamp as claimed in claim 1, wherein the heat sink fin of each of the LED modules extends downward from a bottom of the base plate.

7. The LED disc lamp as claimed in claim 1, further comprising a light reflection cover, the light reflection cover being fixed on a center portion of the bottom plate of the lamp base and having a cone shape which is enlarged from top to bottom, an outer wall of the light reflection cover being wrapped with a light reflection member.

8. The LED disc lamp as claimed in claim 7, wherein an upper end of the light reflection cover is provided with a pipe to be inserted through a through hole of the lampshade and exposed out of the lampshade, an outer wall of the pipe having threads, the light reflection cover having a lid, the lid having inner threads corresponding to the threads on the outer wall of the pipe, the lid being screwed to the pipe.
